(19) United States
(12) Patent Application Publication
(10) Pub. No.: US 2025/0023991 A1
(43) Pub. Date: Jan. 16, 2025

(54) INFORMATION PROCESSING SYSTEM AND NON-TRANSITORY COMPUTER READABLE MEDIUM

(71) Applicant: FUJIFILM Business Innovation Corp., Tokyo (JP)

(72) Inventor: Yasushi SANO, Kanagawa (JP)

(73) Assignee: FUJIFILM Business Innovation Corp., Tokyo (JP)

(21) Appl. No.: 18/591,056

(22) Filed: Feb. 29, 2024

(30) Foreign Application Priority Data
Jul. 10, 2023 (JP) 2023-113160

(51) Int. Cl. H04N 1/00

(52) U.S. Cl. CPC H04N 1/00824; H04N 1/00204; H04N 1/00811; H04N 1/00814; H04N 2201/0074

(57) ABSTRACT

An information processing system includes one or more processors configured to: notify a terminal, in a case where a document to be subjected to reading processing by an image processing apparatus remotely connected to the terminal is set in the image processing apparatus, that the document has been set and a user who has set the document is not identified; and notify the terminal, in a case where the document is set in the image processing apparatus when the image processing apparatus acquires identification information for identifying the user, of the identification information.

### CROSS-REFERENCE TO RELATED APPLICATIONS

This application is based on and claims priority under 35 USC 119 from Japanese Patent Application No. 2023-113160 filed Jul. 10, 2023.

### BACKGROUND

### (i) Technical Field

The present disclosure relates to an information processing system and a non-transitory computer readable medium.

### (ii) Related Art

There is known a technique for connecting a remote terminal to an image processing apparatus, such as a so-called multifunction peripheral, which enables printing, reading, and the like of a document, so that the image processing apparatus can be remotely operated (for example, Japanese Unexamined Patent Application Publication No. 2015-207875). Such a technique enables an operation for causing the image processing apparatus to read a set document and an operation for acquiring information of the read document to be performed from the remote terminal.

### SUMMARY

However, a person who remotely operates the image processing apparatus may not be able to confirm the set document by himself/herself at the start of reading of the document, for example, as in a case where the person requests another person to perform work of setting a document to be read by the image processing apparatus. In such a case, there is a possibility that the person who remotely operates the image processing apparatus performs an instruction to read an unintended document.

Aspects of non-limiting embodiments of the present disclosure relate to preventing a person who remotely operates an image processing apparatus from performing an instruction to read an unintended document.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including one or more processors configured to: notify a terminal, in a case where a document to be subjected to reading processing by an image processing apparatus remotely connected to the terminal is set in the image processing apparatus, that the document has been set and a user who has set the document is not identified; and notify the terminal, in a case where the document is set in the image processing apparatus when the image processing apparatus acquires identification information for identifying the user, of the identification information.

### BRIEF DESCRIPTION OF THE DRAWINGS

Exemplary embodiments of the present disclosure will be described in detail based on the following figures, wherein:

FIG. 1 is a diagram illustrating an example of an overall configuration of an information processing system to which the present exemplary embodiment is applied;

FIG. 2 is a diagram illustrating an example of a hardware configuration of an image processing apparatus;

FIG. 3 is a diagram illustrating an example of a functional configuration of a control unit of the image processing apparatus;

FIG. 4 is a diagram illustrating an example of a functional configuration of a control unit of a user terminal;

FIG. 5 is a flowchart illustrating an example of a flow of processing of the image processing apparatus;

FIG. 6 is a flowchart illustrating an example of a flow of processing of the user terminal;

FIG. 7 is a diagram illustrating a specific example of a relationship among a first user who performs an instruction to execute reading processing by a remote operation on the image processing apparatus from the user terminal, a second user who sets a document to be subjected to the reading processing in the image processing apparatus in response to a request from the first user, and a third user who performs an instruction to execute the reading processing by a direct operation on the image processing apparatus;

FIG. 8 is a diagram illustrating a specific example of processing when the second user who has set the document in the image processing apparatus based on the request from the first user resets the document;

FIG. 9 is a diagram illustrating a specific example of processing when each of the second user requested by the first user and the third user who is a third party sets a document in the image processing apparatus and holds an integrated circuit (IC) card over the image processing apparatus;

FIG. 10 is a diagram illustrating a specific example of information displayed on the user terminal when there are a plurality of users who set documents in the image processing apparatus; and

FIG. 11 is a diagram illustrating a specific example of a case where the second user who has set the document in the image processing apparatus based on the request from the first user inputs a number of sheets of the set document as a direct operation on the image processing apparatus.

### DETAILED DESCRIPTION

In the following, exemplary embodiments of the present disclosure will be described in detail with reference to the accompanying drawings.

### Configuration of Information Processing System

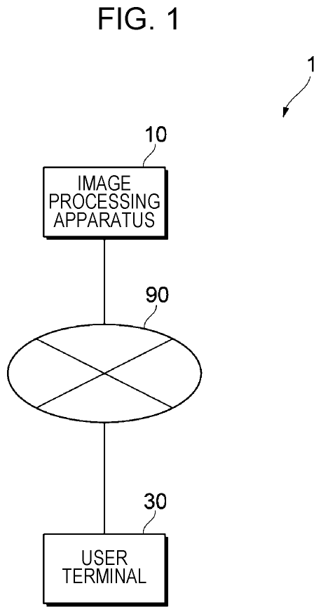

FIG. 1 is a diagram illustrating an example of an overall configuration of an information processing system 1 to which the present exemplary embodiment is applied.

The information processing system 1 includes an image processing apparatus 10 and a user terminal 30 that are connected to each other via a network 90. The network 90 is, for example, a local area network (LAN) or the Internet.

### Image Processing Apparatus

The image processing apparatus 10 is an information processing apparatus that performs various kinds of processing in response to an input operation performed by a user who uses the information processing system 1. For example, the image processing apparatus 10 performs printing processing of forming and outputting an image on a medium such as a sheet, copying processing of copying and outputting an image of a document on a medium such as a sheet, reading processing of reading an image formed on a sheet or the like, facsimile processing of transmitting a document by facsimile, and the like. Examples of the image processing apparatus 10 include a so-called electrophotographic multifunction peripheral that forms a toner image on a printing surface of a sheet, a so-called inkjet printer that ejects ink onto a printing surface of a sheet, and the like.

The image processing apparatus 10 displays a user interface, receives an input operation on the user interface, and acquires the input information. The input operation on the user interface is divided into a direct operation and a remote operation. The direct operation is a direct input operation on the user interface displayed on the image processing apparatus 10 by the user facing the image processing apparatus 10. The remote operation is an indirect input operation on the user interface of the image processing apparatus 10 displayed in a shared manner on the user terminal 30 by the user who operates the user terminal 30 remotely connected to the image processing apparatus 10.

Further, the image processing apparatus 10 acquires various kinds of information transmitted from the user terminal 30 and performs various kinds of processing. For example, the image processing apparatus 10 receives a job execution instruction from the user and executes the job. The “job” is a unit that indicates predetermined processing to be executed by the image processing apparatus 10 (for example, printing processing of forming and outputting an image on a medium such as a sheet, copying processing of copying and outputting an image of a document on a medium such as a sheet, reading processing of reading an image formed on a sheet or the like, facsimile processing of transmitting a document by facsimile, and the like). Further, the image processing apparatus 10 transmits various kinds of information to the user terminal 30.

For example, in a case where the image processing apparatus 10 is remotely connected to the user terminal 30, when a document to be subjected to reading processing is set, the image processing apparatus 10 notifies the user terminal 30 that the document has been set and a user who has set the document is not identified (hereinafter, may be referred to as “a user is unidentified”). Thereafter, when the image processing apparatus 10 acquires information for identifying the user who has set the document (hereinafter, referred to as “user identification information”), in a case where a document is set, the image processing apparatus 10 notifies the user terminal 30 of the acquired user identification information.

A method by which the image processing apparatus 10 acquires the user identification information is not particularly limited. For example, the image processing apparatus 10 may acquire the user identification information provided by a direct operation of the user. In this case, examples of the direct operation include an operation of causing the image processing apparatus 10 to read the user identification information associated with a predetermined medium (for example, an IC card), an operation of inputting the user identification information to a user interface of the image processing apparatus 10, and the like.

The image processing apparatus 10 starts reading processing in a case where an instruction to execute the reading processing is performed on the image processing apparatus 10 from the user terminal 30. In a case where the image processing apparatus 10 detects that a set document to be subjected to the reading processing is removed after the document is set and before the instruction to execute the reading processing is performed, the image processing apparatus 10 notifies the user terminal 30 of the removal.

The image processing apparatus 10 stops the reading processing, in a case where the image processing apparatus 10 detects that the number of sheets of the document when the document is set is different from the number of sheets of the document counted in the reading processing, after the image processing apparatus 10 starts the reading processing in response to the instruction to execute the reading processing to the image processing apparatus 10 from the user terminal 30. Then, the image processing apparatus 10 notifies the user terminal 30 that the reading processing has been stopped.

In this case, a method by which the image processing apparatus 10 specifies the number of sheets of the document when the document is set is not particularly limited. For example, the image processing apparatus 10 may specify the number of sheets of the document when the document is set, based on information related to the number of sheets of the document to be subjected to reading processing, which is provided based on a direct operation of the user who sets the document or which is provided from the user terminal 30. Note that details of the configuration and processing of the image processing apparatus 10 will be described later.

### User Terminal

The user terminal 30 is an information processing apparatus such as a smartphone, a tablet terminal, or a personal computer operated by a user who uses the information processing system 1. Application software that enables a remote operation of the image processing apparatus 10 is installed in the user terminal 30.

The user terminal 30 acquires various kinds of information transmitted from the image processing apparatus 10 and performs various kinds of processing. Further, the user terminal 30 transmits various kinds of information to the image processing apparatus 10. For example, the user terminal 30 displays a user interface of the remotely connected image processing apparatus 10 in a shred manner. Furthermore, the user terminal 30 receives an input operation on the user interface displayed in a shared manner and acquires the input information.

For example, in a case where an input operation for causing the image processing apparatus 10 to execute a job is performed as an input operation on the user interface displayed in a shared manner, the user terminal 30 transmits the input information to the image processing apparatus 10 to request job execution. Further, the user terminal 30 acquires control information transmitted from the image processing apparatus 10, and performs various kinds of processing based on the control information. For example, the user terminal 30 displays various kinds of information based on the control information for causing the various kinds of information to be displayed, which is transmitted from the image processing apparatus 10.

Furthermore, when the user terminal 30 is notified, as a notification from the image processing apparatus 10, that the document has been set in the image processing apparatus 10 and a user is unidentified, the user terminal 30 displays an indication that a document has been set and a user is unidentified. Further, in a case where the user terminal 30 is notified of user identification information as a notification from the image processing apparatus 10 after the user who has set the document provides the user identification information to the image processing apparatus 10, the user terminal 30 displays the user identification information.

In a case where an input operation for instructing execution of reading processing is performed, the user terminal 30 transmits the input information to the image processing apparatus 10. In a case where the user terminal 30 is notified that reading processing has been stopped as a notification from the image processing apparatus 10, the user terminal 30 displays an indication that reading processing has been stopped. Furthermore, in a case where the user terminal 30 is notified that reading processing has been completed as a notification from the image processing apparatus 10, the user terminal 30 displays an indication that reading processing has been completed. The configuration and processing of the user terminal 30 will be described in detail later.

The configuration of the information processing system 1 described above is an example, and it is sufficient that the information processing system 1 as a whole has functions for realizing the above-described processing. For this reason, some or all of the functions for realizing the above-described processing may be distributed in the information processing system 1 or may be provided by cooperation. That is, some or all of the functions of the user terminal 30 may be implemented as functions of the image processing apparatus 10, and some or all of the functions of the image processing apparatus 10 may be implemented as functions of the user terminal 30. Furthermore, some or all of the functions of each of the user terminal 30 and the image processing apparatus 10 of the information processing system 1 may be transferred to another server or the like (not illustrated). Thus, the processing of the information processing system 1 as a whole is promoted, and the processing can be complemented with each other.

### Hardware Configuration of Image Processing Apparatus

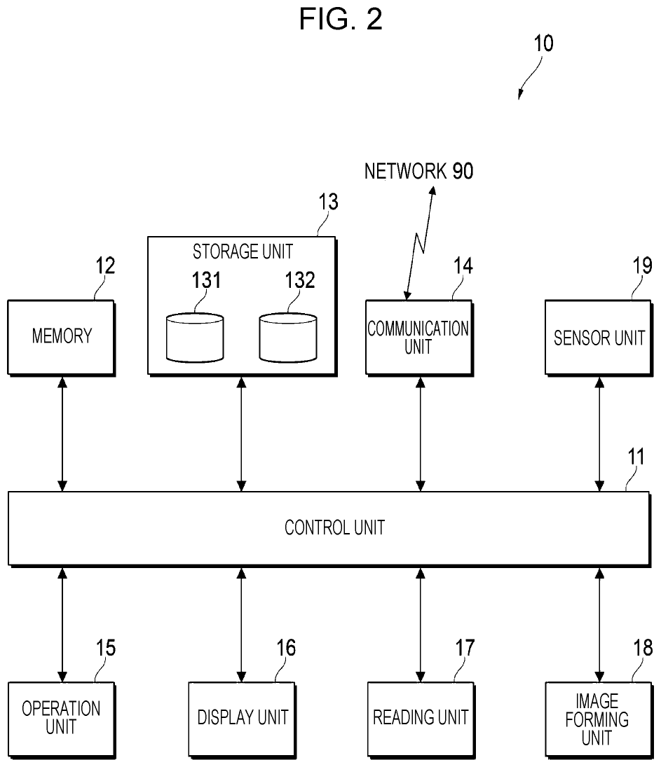

FIG. 2 is a diagram illustrating an example of a hardware configuration of the image processing apparatus 10.

The image processing apparatus 10 includes a control unit 11, a memory 12, a storage unit 13, a communication unit 14, an operation unit 15, a display unit 16, a reading unit 17, an image forming unit 18, and a sensor unit 19. These units are connected to each other via a data bus, an address bus, a peripheral component interconnect (PCI) bus, or the like.

The control unit 11 is a processor that performs control of the functions of the user terminal 30 through execution of various kinds of software such as an operating system (OS) (basic software) and application software. The control unit 11 includes, for example, a central processing unit (CPU). The memory 12 is a storage area for storing various kinds of software, data used for executing the software, and the like, and is used as a work area for calculation. The memory 12 includes, for example, a random access memory (RAM).

The storage unit 13 is a storage area for storing input data to various kinds of software, output data from various kinds of software, and the like. The storage unit 13 includes, for example, a hard disk drive (HDD), a solid state drive (SSD), a semiconductor memory, or the like that is used to store programs, various kinds of setting data, and the like. The storage unit 13 is provided with, as a database (DB) for storing various kinds of information, for example, a user DB 131 in which user identification information is stored, a document DB 132 in which information related to a document to be subjected to reading processing (hereinafter, referred to as “document information”) is stored, or the like.

The communication unit 14 transmits and receives data to and from the user terminal 30 and an external apparatus via the network 90. The operation unit 15 includes, for example, a software keyboard, a mechanical button, a switch, and the like, and receives an input operation. The operation unit 15 also includes a touch sensor that constitutes a touch panel integrally with the display unit 16. The display unit 16 includes, for example, a liquid crystal display or an organic electroluminescence (EL) display used for displaying information, and displays data such as an image or a text.

The reading unit 17 reads an image recorded on a medium (for example, a document of a paper medium or the like) such as a sheet serving as a recording medium. The reading unit 17 includes, for example, a CCD-type scanner in which reflected light of light emitted from a light source to a document is reduced by a lens and received by a charge coupled device (CCD), a CIS-type scanner in which reflected light of light sequentially emitted from a light-emitting diode (LED) light source to a document is received by a contact image sensor (CIS), or the like. The reading unit 17 reads, via a camera, information (for example, a Quick Response (QR) code (registered trademark) or the like) of an image displayed on the display unit 16.

The image forming unit 18 forms an image to be printed on a printing surface of a sheet serving as a recording medium by, for example, an electrophotographic system or an inkjet system. The sensor unit 19 includes various kinds of sensors such as a human detection sensor, an ambient light sensor, a proximity sensor, an optical sensor of light detection and ranging (LiDAR) or the like, and an acceleration sensor, and detects, for example, a document set in the image processing apparatus 10.

### Hardware Configuration of User Terminal

The hardware configuration of the user terminal 30 is similar to the hardware configuration of the image processing apparatus 10 illustrated in FIG. 2 except for the image forming unit 18 and the sensor unit 19. That is, the user terminal 30 includes a control unit, a memory, a storage unit, a communication unit, an operation unit, a display unit, and a reading unit having functions similar to those of the control unit 11, the memory 12, the storage unit 13, the communication unit 14, the operation unit 15, the display unit 16, and the reading unit 17 in FIG. 2, respectively, and illustration and description thereof will be omitted.

### Functional Configuration of Control Unit of Image Processing Apparatus

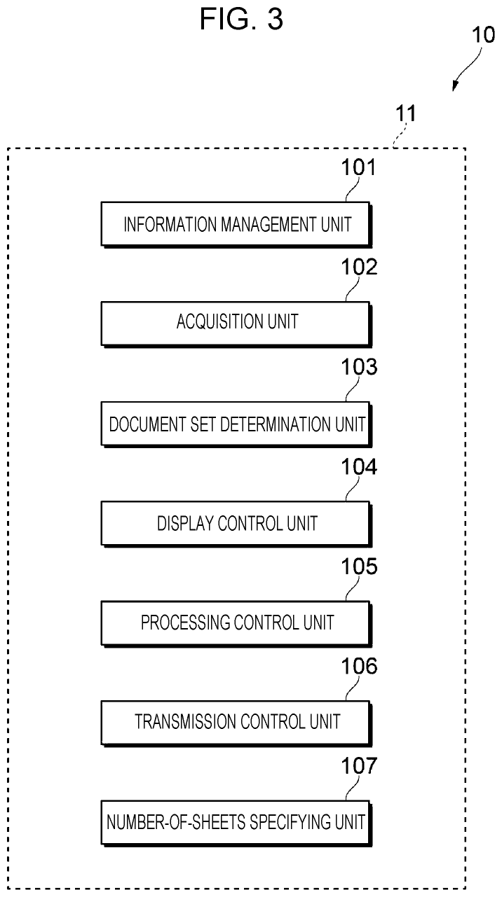

FIG. 3 is a diagram illustrating an example of a functional configuration of the control unit 11 of the image processing apparatus 10.

The control unit 11 of the image processing apparatus 10 functions as an information management unit 101, an acquisition unit 102, a document set determination unit 103, a display control unit 104, a processing control unit 105, a transmission control unit 106, and a number-of-sheets specifying unit 107.

The information management unit 101 stores and manages various kinds of information in the databases of the storage unit 13 (see FIG. 2). For example, the information management unit 101 stores and manages user information in the user DB 131. The user information includes, for example, user identification information and information with which the image processing apparatus 10 that the user can use can be specified. The information management unit 101 stores and manages document information in the document DB 132. The document information includes information such as the number of sheets of a document to be processed by the image processing apparatus 10 and a size of the sheet of the document, set for each job.

The acquisition unit 102 acquires various kinds of information. For example, the acquisition unit 102 acquires various kinds of information transmitted from the user terminal 30. Examples of the information transmitted from the user terminal 30 include input information input for causing the image processing apparatus 10 to execute various kinds of jobs. Examples of the input information input for causing the image processing apparatus 10 to execute various kinds of jobs include information input for causing the image processing apparatus 10 to execute reading processing.

The document set determination unit 103 determines whether a document to be subjected to reading processing has been set in the image processing apparatus 10. The document set determination unit 103 determines whether a document has been set, for example, based on a result of sensing by the sensor unit 19 (see FIG. 2).

The display control unit 104 performs control for causing the display unit 16 (see FIG. 2) to display various kinds of information. For example, the display control unit 104 performs control for causing the display unit 16 to display a user interface. Further, the display control unit 104 performs control for causing various kinds of information to be displayed on the display unit of the user terminal 30. For example, the display control unit 104 performs control for displaying, on the display unit of the user terminal 30 in a shared manner, the user interface displayed on the display unit 16.

The display control unit 104 performs control for causing the display unit of the user terminal 30 to display an indication that a document has been set in the image processing apparatus 10. Further, the display control unit 104 performs control for causing the display unit of the user terminal 30 to display an indication that a user who has set a document in the image processing apparatus 10 is unidentified. In addition, the display control unit 104 performs control for causing the display unit of the user terminal 30 to display user identification information, an indication that reading processing has been stopped, an indication that reading processing has been completed, and the like, which the user terminal 30 is notified of from the image processing apparatus 10.

The processing control unit 105 performs control for causing the image processing apparatus 10 to execute predetermined processing. For example, the processing control unit 105 performs control for causing the image processing apparatus 10 to execute processing such as printing processing, copying processing, reading processing, or facsimile processing based on a job execution request from the user terminal 30. Furthermore, when the image processing apparatus 10 is performing reading processing based on the job execution request from the user terminal 30, in a case where it is detected that the number of sheets of a document when the document is set is different from the number of sheets of the document counted in the reading processing, the processing control unit 105 stops the reading processing.

The transmission control unit 106 performs control for causing various kinds of information to be transmitted via the communication unit 14 (see FIG. 2). For example, the transmission control unit 106 performs control for causing various kinds of information to be transmitted to the user terminal 30. Examples of the information transmitted to the user terminal 30 include control information for causing the user terminal 30 to execute various kinds of processing, and the like.

Examples of the control information for causing the user terminal 30 to execute various kinds of processing include, for example, control information for displaying, on the display unit of the user terminal 30 in a shared manner, a user interface displayed on the display unit 16 of the image processing apparatus 10, control information for displaying an indication that a document has been set in the image processing apparatus 10, control information for displaying an indication that a user who has set a document in the image processing apparatus 10 is unidentified, control information for displaying user identification information, control information for displaying an indication that reading processing has been stopped, and the like.

The number-of-sheets specifying unit 107 specifies, for each job, the number of sheets of a document to be subjected to reading processing when the document is set in the image processing apparatus 10. For example, the number-of-sheets specifying unit 107 refers to document information stored in the document DB 132 of the storage unit 13 (see FIG. 2) to specify the number of sheets of the document when the document is set in the image processing apparatus 10. The number-of-sheets specifying unit 107 also specifies, for each job, the number of sheets of the document counted by a counter in the reading processing. The number-of-sheets specifying unit 107 also specifies a difference between the number of sheets of the document when the document is set in the image processing apparatus 10 and the number of sheets of the document counted by the counter in the reading processing, which are specified for each job of the reading processing.

### Functional Configuration of Control Unit of User Terminal

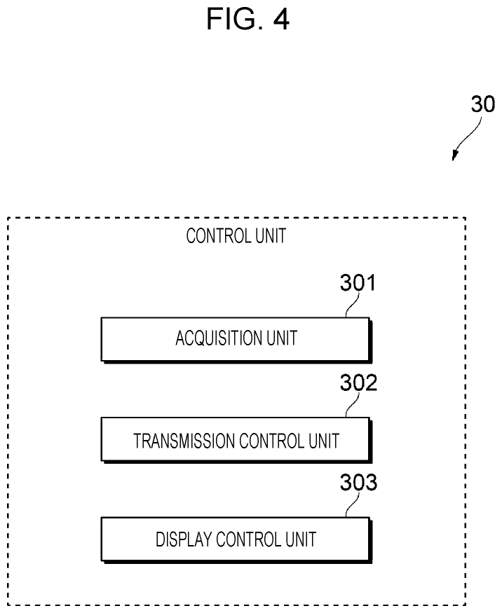

FIG. 4 is a diagram illustrating an example of a functional configuration of the control unit of the user terminal 30.

The control unit of the user terminal 30 functions as an acquisition unit 301, a transmission control unit 302, and a display control unit 303.

The acquisition unit 301 acquires various kinds of information. For example, the acquisition unit 301 acquires input information whose input has been received by the operation unit of the user terminal 30. The acquisition unit 301 also acquires various kinds of information transmitted from the image processing apparatus 10. Examples of the information transmitted from the image processing apparatus 10 include control information for causing the user terminal 30 to execute various kinds of processing, and the like.

The transmission control unit 302 performs control for causing various kinds of information to be transmitted via the communication unit. For example, the transmission control unit 302 performs control for transmitting various kinds of information to the image processing apparatus 10. Examples of the information transmitted from the user terminal 30 to the image processing apparatus 10 include input information acquired by the acquisition unit 301, and the like. Examples of the input information acquired by the acquisition unit 301 and transmitted to the image processing apparatus 10 include input information input for executing a job, and the like.

The display control unit 303 performs control for causing the display unit to display various kinds of information. For example, the display control unit 303 performs control for displaying, on the display unit of the user terminal 30 in a shared manner, the user interface displayed on the display unit 16 (see FIG. 2) of the image processing apparatus 10. Further, the display control unit 303 performs control for causing the display unit to display an indication that a document has been set in the image processing apparatus 10. Further, the display control unit 303 performs control for causing the display unit to display an indication that a user who has set the document in the image processing apparatus 10 is unidentified.

Further, the display control unit 303 performs control for causing the display unit to display user identification information which the user terminal 30 is notified of from the image processing apparatus 10. Further, the display control unit 303 performs control for causing the display unit to display an indication that reading processing by the image processing apparatus 10 has been stopped. Specifically, the display control unit 303 causes the display unit to display these pieces of information based on the control information from the image processing apparatus 10 acquired by the acquisition unit 301.

### Flow of Processing of Image Processing Apparatus

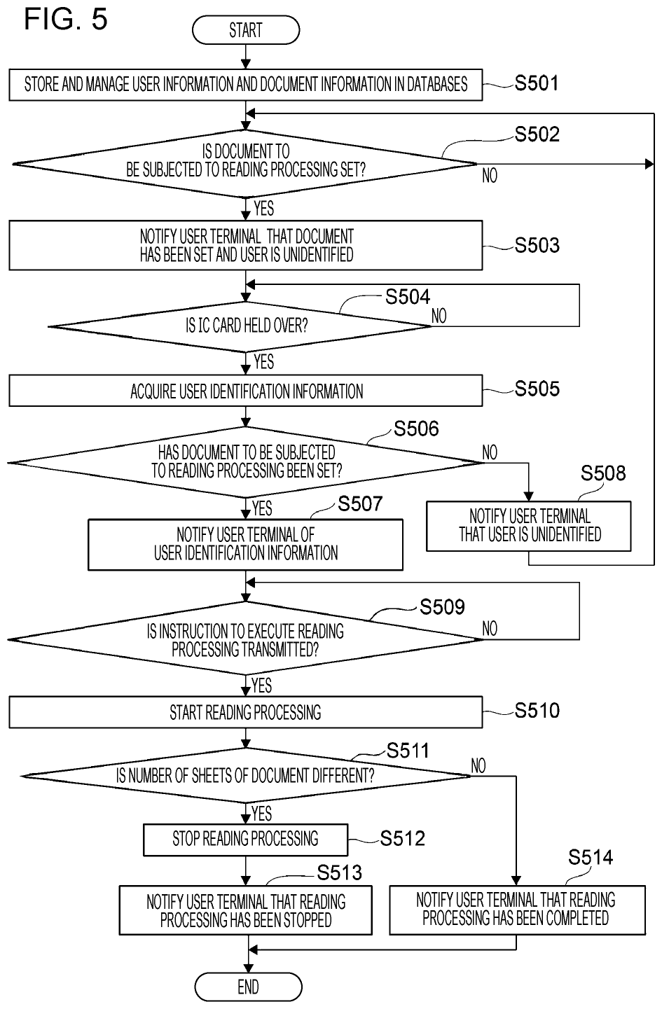

FIG. 5 is a flowchart illustrating an example of a flow of processing of the image processing apparatus 10. Note that the example illustrated in FIG. 5 is based on a configuration in which, when an IC card that is a medium associated with user identification information is held over the image processing apparatus 10, the image processing apparatus 10 reads the user identification information associated with the IC card.

The image processing apparatus 10 stores and manages user information and document information in databases (step S501). Specifically, the image processing apparatus 10 stores and manages the user information including the user identification information in the user DB 131 of the storage unit 13 (see FIG. 2), and stores and manages the document information in the document DB 132.

If a document to be subjected to reading processing is set (YES in step S502), the image processing apparatus 10 notifies the user terminal 30 that the document has been set and a user is unidentified (step S503). On the other hand, if a document to be subjected to reading processing is not set (NO in step S502), the image processing apparatus 10 repeats the determination processing in step S502 until a document to be subjected to reading processing is set.

If an IC card is held over (YES in step S504), the image processing apparatus 10 acquires user identification information associated with the IC card (step S505) and proceeds to determination processing in step S506. On the other hand, if the IC card is not held over the image processing apparatus 10 (NO in step S504), the image processing apparatus 10 repeats the determination processing in step S504 until the IC card is held over the image processing apparatus 10.

If a document to be subjected to reading processing has been set (YES in step S506), the image processing apparatus 10 notifies the user terminal 30 of the user identification information acquired in step S505 (step S507), and proceeds to determination processing in step S509. On the other hand, if a document to be subjected to reading processing has not been set (NO in step S506), the image processing apparatus 10 notifies the user terminal 30 that a user is unidentified (step S508), and returns to the determination processing of step S502.

If an instruction to execute reading processing is transmitted from the user terminal 30 as a job execution request of reading processing (YES in step S509), the image processing apparatus 10 acquires the instruction to execute reading processing and starts reading processing (step S510). Then, the process proceeds to determination processing in step S511. On the other hand, if the instruction to execute reading processing is not transmitted (NO in step S509), the image processing apparatus 10 repeats the determination processing in step S509 until the instruction to execute reading processing is transmitted.

If the image processing apparatus 10 that has started the reading processing detects that the number of sheets of the document is different (YES in step S511), the image processing apparatus 10 stops the reading processing (step S512). Specifically, the image processing apparatus 10 stops the reading processing when the number of sheets of the document when the document is set is different from the number of sheets of the document counted in the reading processing. The image processing apparatus 10 that has stopped the reading processing notifies the user terminal 30 that the reading processing has been stopped (step S513). On the other hand, if it is not detected that the number of sheets of the document is different (NO in step S511), the image processing apparatus 10 continues the reading processing, and when the reading processing is completed, the image processing apparatus 10 notifies the user terminal 30 that the reading processing has been completed (step S514).

### Flow of Processing of User Terminal

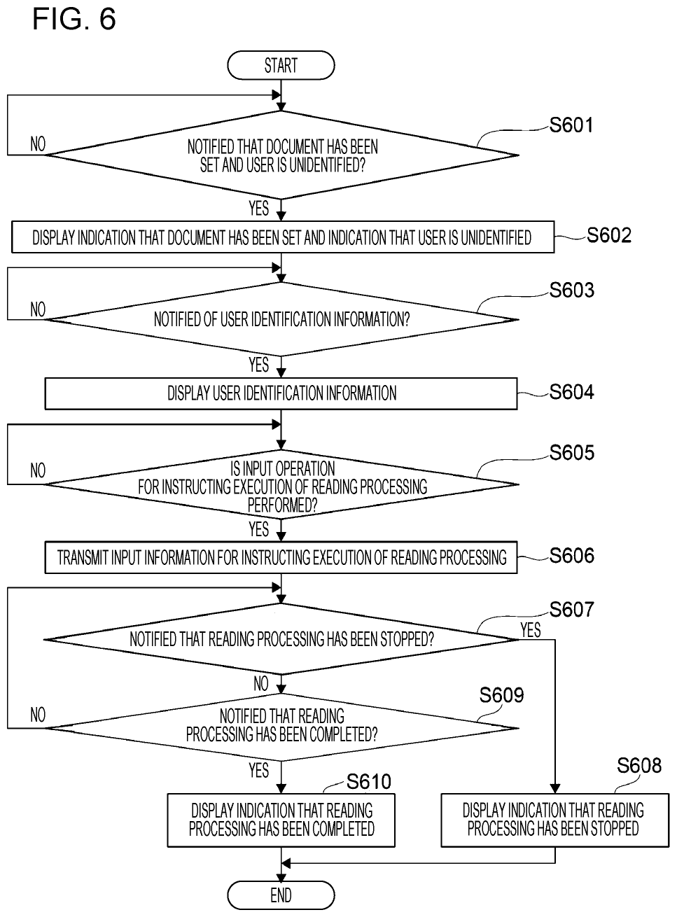

FIG. 6 is a flowchart illustrating an example of a flow of processing of the user terminal 30.

If the user terminal 30 is notified that a document has been set and a user is unidentified as a notification from the image processing apparatus 10 (YES in step S601), the user terminal 30 displays an indication that a document has been set and an indication that a user is unidentified (step S602). On the other hand, if the user terminal 30 is not notified that a document has been set and a user is unidentified (NO in step S601), the user terminal 30 repeats the determination processing in step S601 until the user terminal 30 is notified that a document has been set and a user is unidentified.

If the user terminal 30 is notified of user identification information as a notification from the image processing apparatus 10 (YES in step S603), the user terminal 30 displays the user identification information (step S604), and proceeds to determination processing in step S605. On the other hand, if the user terminal 30 is not notified of the user identification information (NO in step S603), the user terminal 30 repeats the determination processing in step S603 until the user terminal 30 is notified of the user identification information.

If an input operation for instructing execution of reading processing is performed (YES in step S605), the user terminal 30 transmits input information for instructing execution of reading processing to the image processing apparatus 10 (step S606), and proceeds to determination processing in step S607. On the other hand, if the input operation for instructing execution of reading processing is not performed (NO in step S605), the user terminal 30 repeats the determination processing in step S605 until the input operation for instructing execution of reading processing is performed.

If the user terminal 30 is notified that reading processing has been stopped as a notification from the image processing apparatus 10 (YES in step S607), the user terminal 30 displays an indication that reading processing has been stopped (step S608). On the other hand, if the user terminal 30 is not notified that reading processing has been stopped (NO in step S607) and is notified that reading processing has been completed (YES in step S609), the user terminal 30 displays an indication that reading processing has been completed (step S610). If there is neither the notification that reading processing has been stopped (NO in step S607) nor the notification that reading processing has been completed (NO in step S609), the user terminal 30 repeats the determination processing in step S607 and step S609 until there is the notification that reading processing has been stopped or the notification that reading processing has been completed.

### Specific Examples

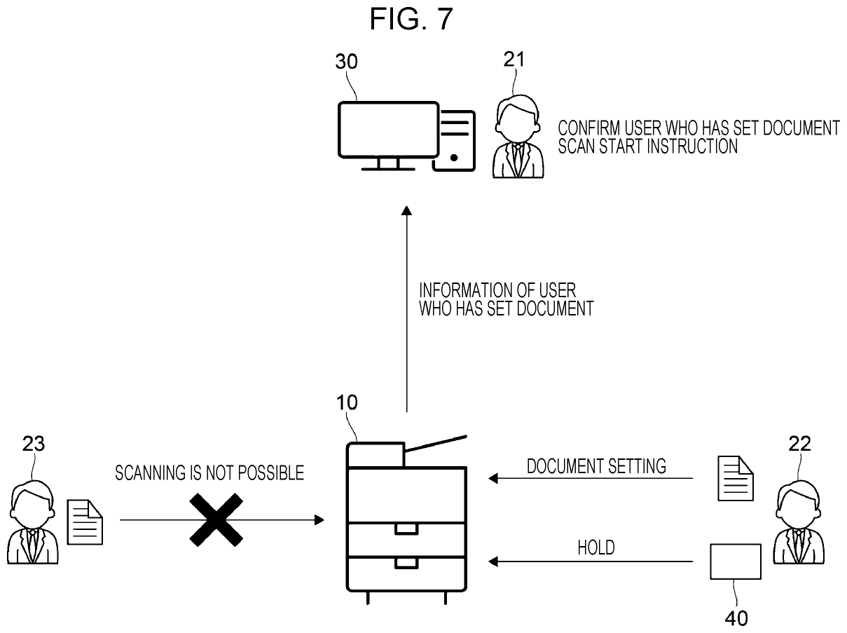

FIG. 7 is a diagram illustrating a specific example of a relationship among a first user 21 who performs an instruction to execute reading processing by a remote operation on the image processing apparatus 10 from the user terminal 30, a second user 22 who sets a document to be subjected to the reading processing in the image processing apparatus 10 in response to a request from the first user 21, and a third user 23 who performs an instruction to execute reading processing by a direct operation on the image processing apparatus 10. Note that in any of the examples illustrated in FIGS. 7 to 11, when an IC card serving as a medium associated with user identification information is held over the image processing apparatus 10, the image processing apparatus 10 reads the user identification information associated with the IC card.

The second user 22 illustrated in FIG. 7 sets a document to be subjected to reading processing by the image processing apparatus 10 in the image processing apparatus 10 and holds an IC card 40 over the image processing apparatus 10, based on a request from the first user 21 who is in a location away from the image processing apparatus 10. Then, the image processing apparatus 10 reads user identification information of the second user 22 from the IC card 40 held thereover, and notifies the user terminal 30 of the user identification information.

The user terminal 30 which is notified of the user identification information displays the user identification information. The first user 21 confirms the user who has set the document in the image processing apparatus 10 from the user identification information displayed on the user terminal 30. At this time, the user identification information displayed on the user terminal 30 may be the user identification information itself, or may be information by which the user can be confirmed at a glance, such as a name of the user associated with the user identification information in advance.

The first user 21 who has confirmed that the user who has set the document in the image processing apparatus 10 is the second user 22 performs an instruction (scan start instruction) for causing the image processing apparatus 10 to execute the reading processing. Specifically, for example, as illustrated in FIG. 7, the confirmation by the first user 21 is performed before a document set by the third user 23 who is not requested by the first user 21 is erroneously read. Therefore, the third user 23 cannot cause the image processing apparatus 10 to execute reading processing (scanning is not possible).

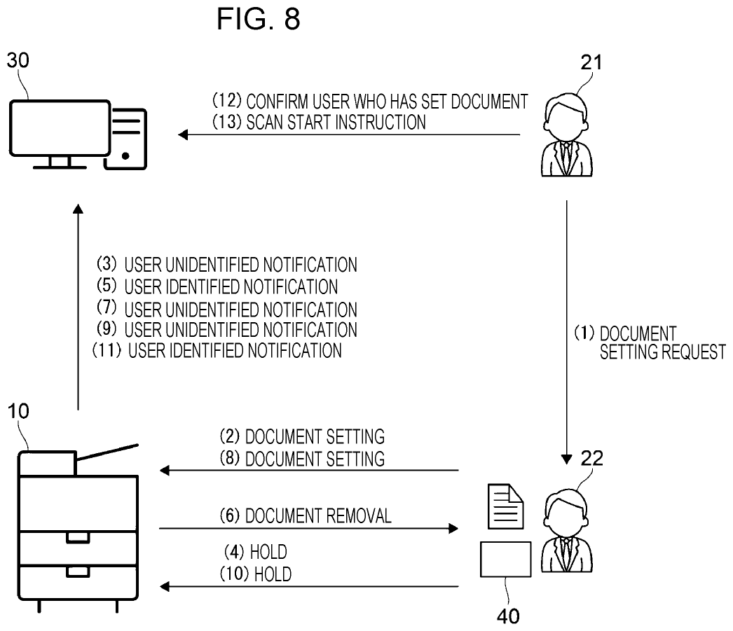

FIG. 8 is a diagram illustrating a specific example of processing performed when the second user 22 who has set the document in the image processing apparatus 10 based on the request from the first user resets the document.

The second user 22 illustrated in FIG. 8 sets a document to be subjected to reading processing by the image processing apparatus 10 in the image processing apparatus 10 ((2) document setting) based on a request ((1) document setting request) from the first user 21 who is in a location away from the image processing apparatus 10. Then, the image processing apparatus 10 notifies the user terminal 30 that the document has been set and a user is unidentified ((3) user unidentified notification).

Next, if the second user 22 holds the IC card 40 over the image processing apparatus 10 ((4) hold), the image processing apparatus 10 reads user identification information of the second user 22 from the IC card 40 held thereover and notifies the user terminal 30 of the user identification information ((5) user identified notification).

If the second user 22 notices that the number of sheets of the document set in the image processing apparatus 10 is insufficient and removes the document from the image processing apparatus 10 ((6) document removal), the image processing apparatus 10 detects that the document has been removed and notifies the user terminal 30 that a user is unidentified ((7) user unidentified notification). This notification is a notification for notifying the first user 21 that the user identification information has been canceled.

If the second user 22 sets a document again in the image processing apparatus 10 ((8) document setting), the image processing apparatus 10 notifies the user terminal 30 that the document has been set and a user is unidentified ((9) user unidentified notification). Subsequently, if the second user 22 holds the IC card 40 over the image processing apparatus 10 ((10) hold), the image processing apparatus 10 reads the user identification information of the second user 22 from the IC card 40 held thereover, and notifies the user terminal 30 of the user identification information ((11) user identified notification).

The first user 21 notified of the user identification information confirms that the user who has set the document in the image processing apparatus 10 is the second user 22 requested by the first user 21 based on the user identification information ((12) confirm user who has set document). Then, the first user 21 operates the user terminal 30 to perform an instruction to execute reading processing ((13) scan start instruction).

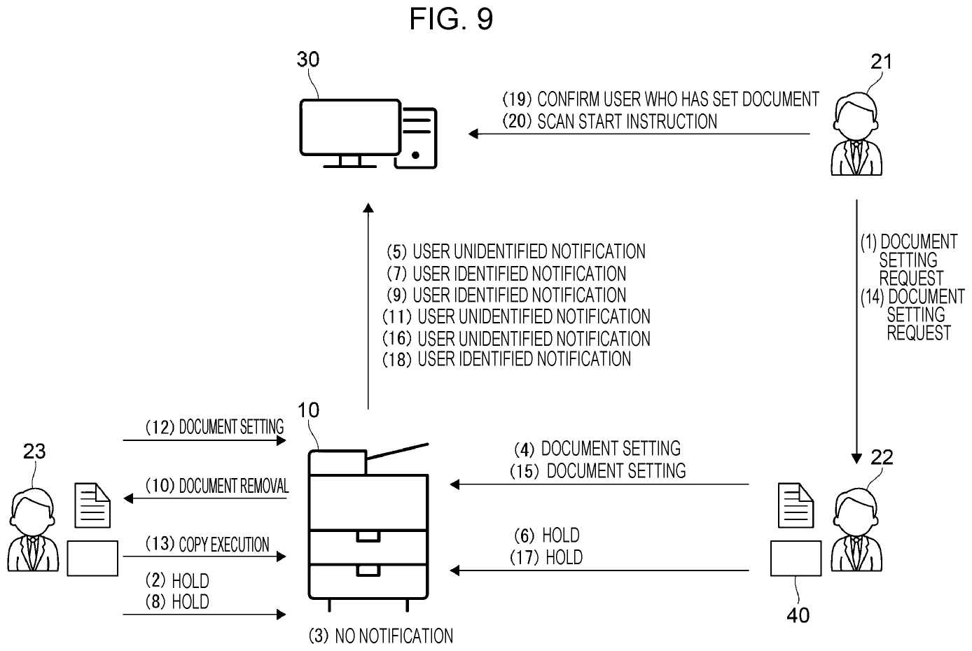

FIG. 9 is a diagram illustrating a specific example of processing when each of the second user 22 requested by the first user and the third user 23 who is a third party sets a document in the image processing apparatus 10 and holds an IC card over the image processing apparatus 10. In the example of FIG. 9, it is assumed that the third user 23 causes the image processing apparatus 10 to execute copying processing.

In a case where the first user 21 who is in a location away from the image processing apparatus 10 requests the second user 22 to set a document to be subjected to reading processing by the image processing apparatus 10 ((1) document setting request), and thereafter, the third user 23 who is a third party holds the IC card 40 over the image processing apparatus 10 before the second user 22 sets the document in the image processing apparatus 10 ((2) hold), the following processing is performed.

That is, the image processing apparatus 10 does not notify the user terminal 30 of anything because a document is not set in the image processing apparatus 10 ((3) no notification). If the second user 22 sets a document requested by the first user 21 in the image processing apparatus 10 ((4) document setting), the image processing apparatus 10 notifies the user terminal 30 that the document has been set and a user is unidentified ((5) user unidentified notification).

Next, if the second user 22 holds the IC card 40 over the image processing apparatus 10 ((6) hold), the image processing apparatus 10 reads user identification information of the second user 22 from the IC card 40 held thereover and notifies the user terminal 30 of the user identification information ((7) user identified notification). If the third user 23 holds the IC card 40 over the image processing apparatus 10 ((8) hold), the image processing apparatus 10 reads user identification information of the third user 23 from the IC card 40 held thereover, and notifies the user terminal 30 of the user identification information ((9) user identified notification).

Then, if the third user 23 removes the document set by the second user 22 in order to cause the image processing apparatus 10 to perform copying processing of his/her own document ((10) document removal), the image processing apparatus 10 detects that the document has been removed and notifies the user terminal 30 that a user is unidentified ((11) user unidentified notification). Then, if the third user 23 sets a document in the image processing apparatus 10 ((12) document setting) and causes the image processing apparatus 10 to execute copy processing, the image processing apparatus 10 executes copy processing ((13) copy execution).

If the first user 21 requests the second user 22 to set a document again ((14) document setting request) and the second user 22 sets a document ((15) document setting), the image processing apparatus 10 notifies the user terminal 30 that the document has been set and a user is unidentified ((16) user unidentified notification). Subsequently, if the second user 22 holds the IC card 40 over the image processing apparatus 10 ((17) hold), the image processing apparatus 10 reads user identification information of the second user 22 from the IC card 40 held thereover, and notifies the user terminal 30 of the user identification information ((18) user identified notification).

The first user 21 notified of the user identification information confirms that the user who has set the document in the image processing apparatus 10 is the second user 22 requested by the first user 21 based on the user identification information ((19) confirm user who has set document). Then, the first user 21 operates the user terminal 30 to perform an instruction to execute reading processing ((20) scan start instruction).

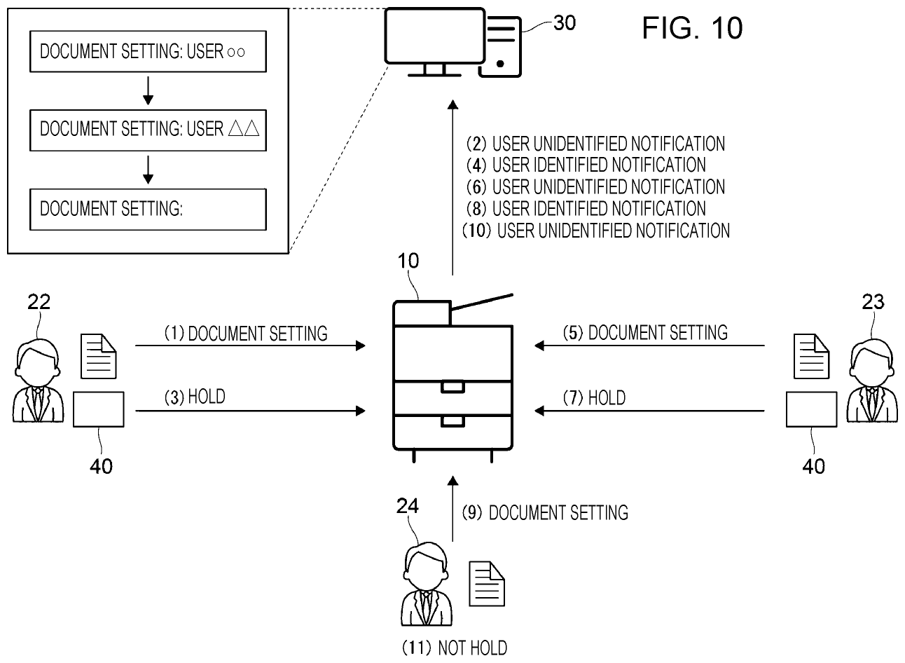

FIG. 10 is a diagram illustrating a specific example of information displayed on the user terminal 30 when there are a plurality of users who set documents in the image processing apparatus 10.

If the second user 22 who has received a request to set a document to be subjected to reading processing by the image processing apparatus 10 from the first user (not illustrated) who is in a location away from the image processing apparatus 10 sets the document in the image processing apparatus 10 ((1) document setting), the image processing apparatus 10 notifies the user terminal 30 that the document has been set and a user is unidentified ((2) user unidentified notification).

Next, if the second user 22 holds the IC card 40 over the image processing apparatus 10 ((3) hold), the image processing apparatus 10 reads user identification information of the second user 22 from the IC card 40 held thereover, and notifies the user terminal 30 of the user identification information ((4) user identified notification).

Next, if the third user 23 sets a document in the image processing apparatus 10 ((5) document setting), the image processing apparatus 10 notifies the user terminal 30 that the document has been set and a user is unidentified ((6) user unidentified notification). Subsequently, if the third user 23 holds the IC card 40 over the image processing apparatus 10 ((7) hold), the image processing apparatus 10 reads user identification information of the third user 23 from the IC card 40 held thereover, and notifies the user terminal 30 of the user identification information ((8) user identified notification).

Next, if a fourth user 24 sets a document in the image processing apparatus 10 ((9) document setting), the image processing apparatus 10 notifies the user terminal 30 that the document has been set and a user is unidentified ((10) user unidentified notification). Thereafter, it is assumed that the fourth user 24 does not hold an IC card over the image processing apparatus 10 ((11) not hold).

When the user terminal 30 acquires user identification information of the user who has set the document in the image processing apparatus 10, the user terminal 30 displays the user identification information. For example, in a case where a name serving as the user identification information is set to be displayed, the name of the user who has set the document is displayed on the user terminal 30.

On a screen of the user terminal 30 illustrated in FIG. 10, it is displayed that the name of the user (the second user 22) who has set the document for the first time is “∘∘” and the name of the user (the third user 23) who has set the document for the second time is “ΔΔ”. However, since the user (the fourth user 24) who has set the document for the third time does not hold the IC card over the image processing apparatus 10 as described above, an indication that the document has been set in the image processing apparatus 10 is displayed on the user terminal 30 but the name of the user is displayed as blank because the name is not identifiable.

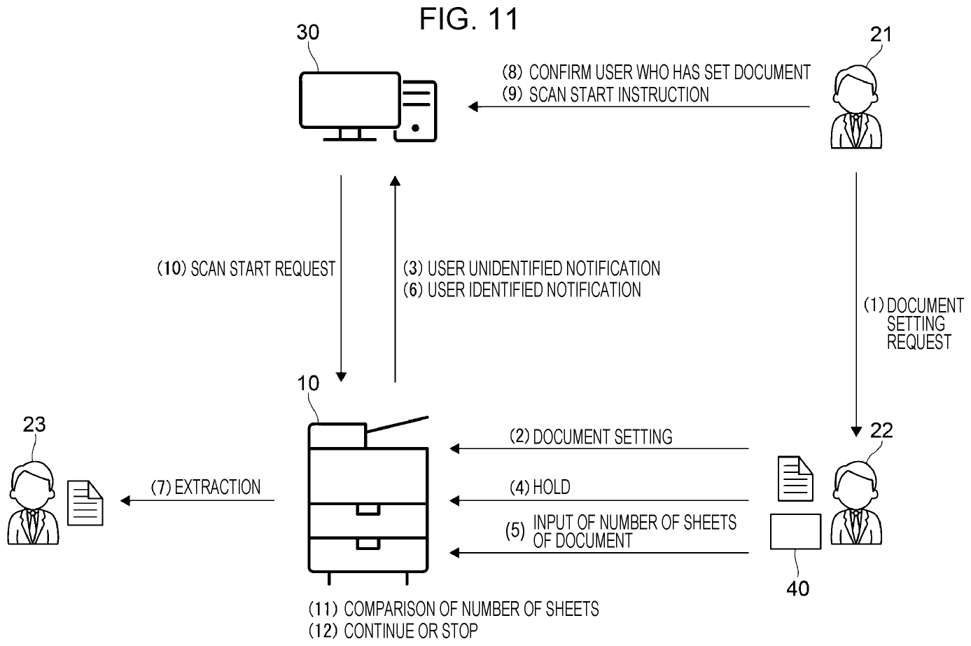

FIG. 11 is a diagram illustrating a specific example of a case where the second user 22 who has set a document in the image processing apparatus 10 based on a request from the first user 21 inputs the number of sheets of the set document as a direct operation on the image processing apparatus 10.

If the second user 22 illustrated in FIG. 11 sets a document to be subjected to reading processing by the image processing apparatus 10 in the image processing apparatus 10 ((2) document setting) based on a request ((1) document setting request) from the first user 21 who is in a location away from the image processing apparatus 10, the image processing apparatus 10 notifies the user terminal 30 that the document has been set and a user is unidentified ((3) user unidentified notification).

Next, if the second user 22 holds the IC card 40 over the image processing apparatus 10 ((4) hold) and inputs the number of sheets of the document set in the image processing apparatus 10 ((5) input of number of sheets of document), the image processing apparatus 10 reads user identification information of the second user 22 from the IC card 40 held thereover and notifies the user terminal 30 of the number of sheets of the document set by the second user 22 together with the user identification information ((6) user identified notification).

Here, it is assumed that the third user 23 extracts a part of the documents set in the image processing apparatus 10 for some reason ((7) extraction). In this case, at least one sheet of the document is set in the image processing apparatus 10, unlike the case where the entire document is removed, for example, as in the examples of FIG. 8 and FIG. 9 described above, and thus the extraction of the document is not detected. As a result, the image processing apparatus 10 does not notify the user terminal 30 that a user is unidentified.

The first user 21 who remains in a state of being notified of the user identification information confirms that the user who has set the document in the image processing apparatus 10 is the second user 22 requested by the first user 21 based on the user identification information ((8) confirm user who has set document). Then, the first user 21 operates the user terminal 30 to perform an instruction to execute reading processing ((9) scan start instruction). Then, the user terminal 30 requests the image processing apparatus 10 to execute a job of the reading processing ((10) scanning start request), and thus the image processing apparatus 10 starts the reading processing. That is, reading processing for the document in a state in which a part thereof is extracted is started.

After starting the reading processing, the image processing apparatus 10 compares the number of sheets of the document when the document has been set with the number of sheets of the document counted in the reading processing ((11) comparison of number of sheets). The reading processing is continued if there is no problem with the comparison result, or the reading processing is stopped if there is a problem with the comparison result ((12) continue or stop). In the example of FIG. 11, since a part of the document is extracted by the third user 23, the number of sheets of the document when the document has been set is different from the number of sheets of the document counted in the reading processing, and the reading processing is stopped.

### Other Exemplary Embodiments

Although the present exemplary embodiment has been described above, the present disclosure is not limited to the above-described exemplary embodiment. Furthermore, the effects of the present disclosure are also not limited to those described in the above-described exemplary embodiment. For example, the configuration of the information processing system 1 illustrated in FIG. 1 and the hardware configuration of the image processing apparatus 10 illustrated in FIG. 2 are both merely examples for achieving the objects of the present disclosure and are not particularly limited. Furthermore, the functional configuration of the image processing apparatus 10 illustrated in FIG. 3 and the functional configuration of the user terminal 30 illustrated in FIG. 4 are also merely examples and are not particularly limited. It is sufficient that the information processing system 1 of FIG. 1 is provided with a function capable of executing the above-described processing as a whole, and which functional configuration is used for realizing the function is not limited to the examples of FIGS. 3 and 4.

In addition, the orders of the steps of the processing of the image processing apparatus 10 illustrated in FIG. 5 and the processing of the user terminal 30 illustrated in FIG. 6 are also merely examples and are not particularly limited. The processing may be performed not only in a time-series manner according to the order of the illustrated steps, but also in parallel or individually without being necessarily performed in a time-series manner. Furthermore, the specific examples illustrated in FIGS. 7 to 11 are also merely examples and are not particularly limited.

### Appendix

(((1)))

An information processing system comprising:
one or more processors configured to:
   notify a terminal, in a case where a document to be subjected to reading processing by an image processing apparatus remotely connected to the terminal is set in the image processing apparatus, that the document has been set and a user who has set the document is not identified; and
   notify the terminal, in a case where the document is set in the image processing apparatus when the image processing apparatus acquires identification information for identifying the user, of the identification information.
(((2)))

The information processing system according to (((1))), wherein the identification information is information provided to the image processing apparatus by a direct operation of the user on the image processing apparatus.
(((3)))

The information processing system according to (((2))), wherein the direct operation of the user is an operation of causing the image processing apparatus to read the identification information associated with a predetermined medium, or an operation of inputting the identification information to a user interface of the image processing apparatus.
(((4)))

The information processing system according to any one of (((1))) to (((3))), wherein the one or more processors are configured to cause the image processing apparatus to start the reading processing in a case where an instruction to execute the reading processing is performed on the image processing apparatus from the terminal.
(((5)))

The information processing system according to (((4))), wherein the one or more processors are configured to notify the terminal, in a case where the document set in the image processing apparatus is removed before the instruction is performed, that the document has been removed.
(((6)))

The information processing system according to (((4))), wherein the one or more processors are configured to stop the reading processing in a case where a number of sheets of the document when the document is set in the image processing apparatus is different from a number of sheets of the document counted in the reading processing.
(((7)))

The information processing system according to any one of ((((4)) to ((6))), wherein the one or more processors are configured to specify a number of sheets of the document when the document is set in the image processing apparatus based on information related to the number of sheets of the document provided in advance from the user or the terminal.
((((8)))

The information processing system according to any one of ((((4))) to ((((7))), wherein the one or more processors are configured to notify the terminal that the reading processing by the image processing apparatus has been stopped.
(((9)))

A program causing a computer to execute a process comprising:
notifying a terminal, in a case where a document to be subjected to reading processing by an image processing apparatus remotely connected to the terminal is set in the image processing apparatus, that the document has been set and a user who has set the document is not identified; and
notifying the terminal, in a case where the document is set in the image processing apparatus when the image processing apparatus acquires identification information for identifying the user, of the identification information.

What is claimed is:

1. An information processing system comprising:
one or more processors configured to:
notify a terminal, in a case where a document to be subjected to reading processing by an image processing apparatus remotely connected to the terminal is set in the image processing apparatus, that the document has been set and a user who has set the document is not identified; and
notify the terminal, in a case where the document is set in the image processing apparatus when the image processing apparatus acquires identification information for identifying the user, of the identification information.

2. The information processing system according to claim 1, wherein
the identification information is information provided to the image processing apparatus by a direct operation of the user on the image processing apparatus.

3. The information processing system according to claim 2, wherein
the direct operation of the user is an operation of causing the image processing apparatus to read the identification information associated with a predetermined medium, or an operation of inputting the identification information to a user interface of the image processing apparatus.

4. The information processing system according to claim 1, wherein
the one or more processors are configured to cause the image processing apparatus to start the reading processing in a case where an instruction to execute the reading processing is performed on the image processing apparatus from the terminal.

5. The information processing system according to claim 4, wherein
the one or more processors are configured to notify the terminal, in a case where the document set in the image processing apparatus is removed before the instruction is performed, that the document has been removed.

6. The information processing system according to claim 4, wherein
the one or more processors are configured to stop the reading processing in a case where a number of sheets of the document when the document is set in the image processing apparatus is different from a number of sheets of the document counted in the reading processing.

7. The information processing system according to claim 6, wherein
the one or more processors are configured to specify the number of sheets of the document when the document is set in the image processing apparatus based on information related to the number of sheets of the document provided in advance from the user or the terminal.

8. The information processing system according to claim 6, wherein
the one or more processors are configured to notify the terminal that the reading processing by the image processing apparatus has been stopped.

9. A non-transitory computer readable medium storing a program causing a computer to execute a process comprising:
notifying a terminal, in a case where a document to be subjected to reading processing by an image processing apparatus remotely connected to the terminal is set in the image processing apparatus, that the document has been set and a user who has set the document is not identified; and
notifying the terminal, in a case where the document is set in the image processing apparatus when the image processing apparatus acquires identification information for identifying the user, of the identification information.
